(19) United States
(12) Patent Application Publication
(10) Pub. No.: US 2009/0102809 A1
(43) Pub. Date: Apr. 23, 2009

(54) Coordinate Detecting Device and Operation Method Using a Touch Panel

(76) Inventors: Norio MAMBA, Kawasaki (JP); Toshiyuki Kumagai, Chigasaki (JP); Tsutomu Furuhashi, Yokohama (JP); Masayoshi Kinoshita, Oita (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/254,039

(22) Filed: Oct. 20, 2008

(30) Foreign Application Priority Data
Oct. 22, 2007 (JP) 2007-273313

(51) Int. Cl. G06F 3/041

(52) U.S. Cl. 345/173

(57) ABSTRACT

In a touch panel capable of detecting the coordinates of two pressed-down points individually at the same time, the coordinates detected while one point is pressed are stored and, if a second point is subsequently pressed, the stored coordinates of a first point are used to identify the coordinates closer to the stored coordinates as the first point and the coordinates of another detected point as the second point, thereby identifying an order in which the two points are pressed. Thereafter, what mouse operation has been executed at the coordinates of the first point is detected based on a positional relation between the coordinates of the first point and the coordinates of the second point, and a result of the detection is output to an application operable through a graphical user interface.

### CROSS-REFERENCE TO RELATED APPLICATION

The present application claims priority from Japanese application JP2007-273313 filed on Oct. 22, 2007, the content of which is hereby incorporated by reference into this application.

### BACKGROUND OF THE INVENTION

1. Field of the Invention

The present invention relates to a method of implementing functions of a pointing device such as a mouse, which is currently commonly used as an input device for operating a graphical user interface on a personal computer or other similar information technology equipment, with a touch panel capable of detecting the coordinates of two or more pressed-down points individually at the same time.

2. Description of the Related Art

A graphical user interface (hereinafter abbreviated as GUI) for performing various types of data processing of application software by selecting an icon or text that is displayed on a display has lately become popular for its user-friendly operation, and is widely employed in information technology equipment, mainly, personal computers, cellular phones, and household gaming machines. The GUI is operated generally by using a pointing device such as a mouse, a track ball, or a button as an input device. With the pointing device, a pointer displayed on a display is operated to select, by clicking a mouse button, an icon or text displayed on the display, and processing of application software is thus executed. A typical pointing device is a mouse. In most cases, a mouse has multiple buttons and which of the buttons is pressed determines what data processing is performed.

What is currently attracting attention, however, is to use a touch panel as a pointing device for GUI operation. A touch panel enables users to directly press (touch) an icon displayed on a display such as a liquid crystal display. This gives touch panels advantages over the above-mentioned mouse and other pointing devices in that users can operate the GUI more intuitively and that operating on the display surface eliminates the need for a space for manipulating the mouse. It is surmised that, in some uses, conventional mice will be replaced by touch panels as a pointing device used in information technology equipment.

A method of replacing the mouse function with a touch panel is proposed in JP09-325851A, where a touch panel capable of detecting the coordinates of one pressed-down point stores coordinates and time at which the touch panel is pressed and, when the same point is pressed again within a given period of time, judges that a double click has been made.

Multiple buttons of a mouse in general are assigned different types of processing (for example, processing executed upon clicking varies depending on whether it is a left click or a right click) It is difficult for a touch panel that detects the coordinates of only one point at a time as in JP 09-325851 A to cover these other mouse functions which utilize multiple buttons.

Thus, a touch panel that is not capable of detecting the coordinates of two or more pressed-down points at the same time cannot fully reproduce the functions of a mouse, since it does not cover other functions than detecting a single click and detecting a double click from a time difference between pressing the touch panel once and pressing it the next time, namely, functions that utilize multiple mouse buttons.

### SUMMARY OF THE INVENTION

An object of the present invention is therefore to provide a touch panel with functions equivalent to common button operations of a mouse, such as drag & drop, left click, and right click.

To attain the above object, a coordinate detecting method according to the present invention uses a touch panel that detects the coordinates of a single point when only one point is pressed and, if a second point is subsequently pressed, detects the coordinates of the first and second points individually at the same time, or that detects and outputs the coordinates of the first point and data identifying whether or not a second point has been pressed. This touch panel is capable of processing in which, when only one point is pressed, a displayed pointer is moved to point at detected coordinates and, when a second point is subsequently pressed, an icon at the coordinates of the first point is selected. An operation similar to drag & drop in a mouse is thus accomplished.

The touch panel is also capable of distinguishing a left click and a right click from each other, when the coordinates of two points are detected, based on the positional relation between the coordinates of the first point and the coordinates of the second point. For example, the touch panel judges that a left click has been made when the coordinates of the second point indicate a location to the left of the first point, and judges that a right click has been made when the second point is to the right of the first point.

According to the present invention, the major button-operated functions of a mouse (e.g., drag & drop, left click, and right click) can be implemented by a touch panel by making the touch panel capable of detecting two pressed-down points individually at the same time.

According to the present invention, where the button-operated functions of a mouse commonly used as a pointing device for GUI operation in information technology equipment are implemented by a touch panel capable of detecting the coordinates of two pressed-down points individually at the same time, a mouse can be replaced by a touch panel that can be operated intuitively. Furthermore, unlike a mouse which needs a certain space for manipulation, the touch panel which enables the operation to be performed on the display surface does not require a manipulation space.

### BRIEF DESCRIPTION OF THE DRAWINGS

These and other features, objects and advantages of the present invention will become more apparent from the following description when taken in conjunction with the accompanying drawings wherein:

FIG. 1 is a structural diagram of a coordinate detecting device according to the present invention;

FIG. 2 is a diagram outlining an application that is used to describe the present invention;

FIG. 3 is a flow chart illustrating a coordinate analyzing method according to a first embodiment of the present invention;

FIGS. 4A and 4B are diagrams illustrating an example of an application according to the first embodiment of the present invention;

FIG. 5 is a flow chart illustrating a coordinate analyzing method according to a second embodiment of the present invention;

FIGS. 6A to 6c are diagrams illustrating an example 1 of an application according to the second embodiment of the present invention;

FIGS. 7A to 7c are diagrams illustrating an example 2 of the application according to the second embodiment of the present invention;

FIG. 8 is a flow chart illustrating a coordinate analyzing method according to a third embodiment of the present invention; and

FIGS. 9A to 9c are diagrams illustrating an example of an application according to the third embodiment of the present invention.

### DETAILED DESCRIPTION OF THE INVENTION

Hereinafter, descriptions are made of first to third embodiments of the present invention.

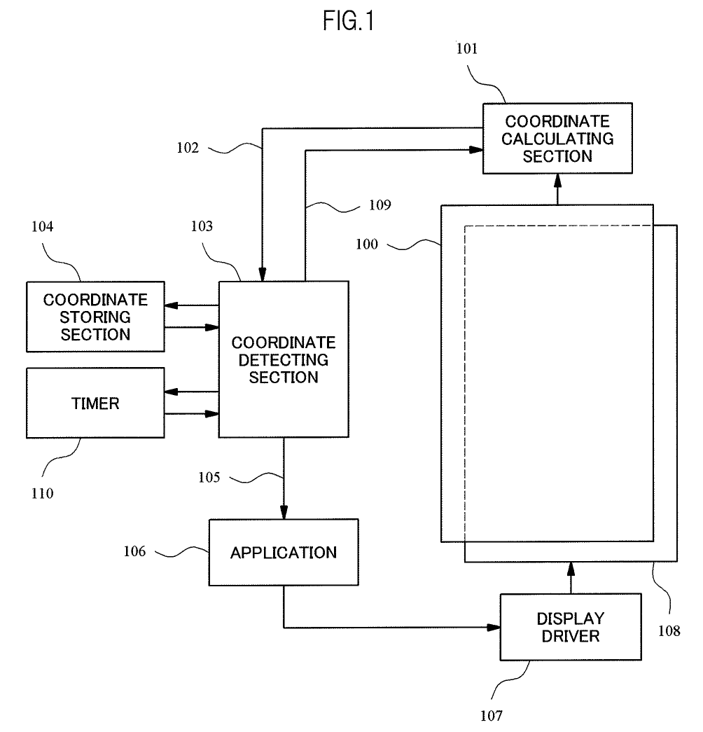

A method of detecting coordinates on a capacitive touch panel according to the present invention will be described. FIG. 1 illustrates a structural diagram of a coordinate detecting device according to the first embodiment of the present invention.

The coordinate detecting device of FIG. 1 includes a touch panel 100, which is capable of detecting multiple (two or more) points, a coordinate calculating section 101, which is capable of simultaneously (in parallel, in an overlapping manner) calculating the coordinates of multiple points where the touch panel 100 is pressed and which outputs calculated coordinate data 102 of a single or multiple points, a coordinate detecting section 103, which determines what processing is to be performed based on the coordinate data 102 calculated in the coordinate calculating section 101, a coordinate storing section 104, which stores the coordinate data 102 calculated in the coordinate calculating section 101, a timer 110, which measures an arbitrary length of time upon command from the coordinate detecting section 103, an application 106, which is operable through a GUI with the use of a coordinate detection result 105 about coordinates and processing specifics output from the coordinate detecting section 103, a display 108, which displays an output result of the application 106, and a display driver 107, which converts an output result of the application 106 into a data format processible by the display 108. The coordinate detecting section 103 has a function of outputting a control command 109 to the coordinate calculating section 101. For example, when the timer 110 registers a passing of a preset length of time without the touch panel 100 being pressed, the coordinate detecting section 103 may command the coordinate calculating section 101 to lengthen the interval (cycle) of calculating coordinates in order to save power. When coordinates are kept detected for longer than the preset length of time, the coordinate detecting section 103 may command the coordinate calculating section 101 to shorten the interval (cycle) of detecting coordinates.

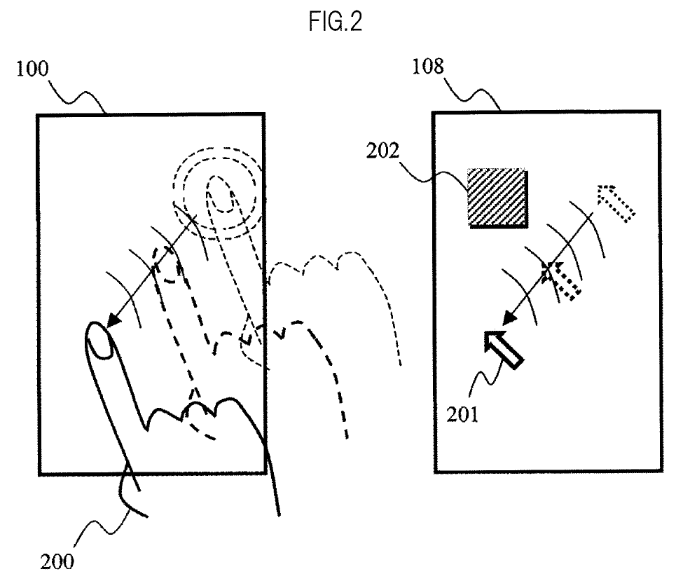

Described next with reference to FIG. 2 is an example of the application 106 according to this embodiment. The application 106 of FIG. 2 is operated such that, when a finger 200 presses the touch panel 100 and slides over the touch panel 100 without losing contact with the touch panel 100, a pointer 201 is displayed at corresponding coordinates on the display 108 and used to select an icon (object) 202, which is an image or text displayed on the display 108.

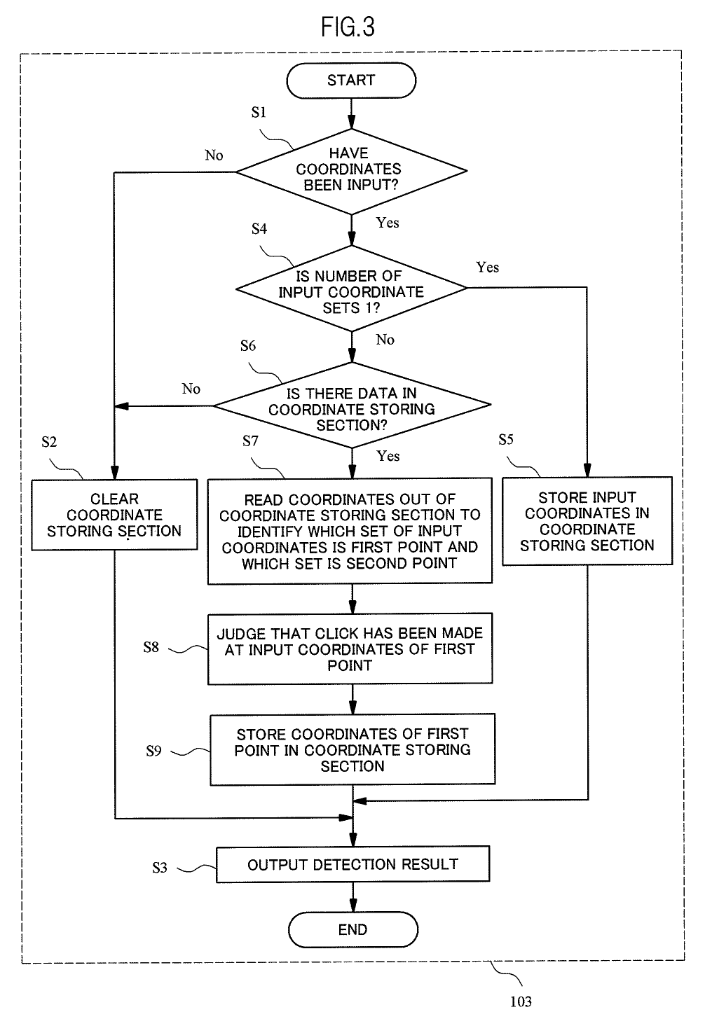

A coordinate detecting method for implementing the one-button click function of a mouse with the touch panel 100 which is what the first embodiment of the present invention is about will be described with reference to a flow chart of FIG. 3 which illustrates processing steps of the coordinate detecting section 103.

First, the coordinate detecting section 103 judges in Step S1 whether or not the coordinate data 102 has been input from the coordinate detecting section 101. When no coordinates have been input (S1: No), the coordinate storing section 104 is cleared in S2 and the coordinate detection result 105 indicating that coordinates have not been detected is output in S3.

When it is judged in S1 that coordinates have been input (Yes), on the other hand, whether or not the input coordinates are of one point is judged in S4. When the coordinates of only one point have been input (Yes), the input coordinates are stored in the coordinate storing section 104 in S5, then the input coordinate data of the single point is output as the coordinate detection result 105 in S3, and then the coordinate detection is ended.

When it is judged in S4 that the coordinates of two points have been input (No), whether or not there is data in the coordinate storing section 104 is judged in S6. When no data is found in the coordinate storing section 104 (S6: No), the coordinate storing section 104 is cleared in S2 and the coordinate detection is ended. When data is found in the coordinate storing section 104 in S6 (Yes), it means that, after one point on the touch panel 100 is pressed, a second point is pressed while the first point is kept pressed. In this case, the coordinates that have been input the last time are read out of the coordinate storing section 104 in S7. Of the coordinates of the two points input this time, the coordinates of one point that are closer to the read coordinates are identified as the coordinates of the first point and the coordinates of the other point is identified as the coordinates of the second point. By this identification processing, the first point and the second point can be distinguished from each other even when pressing the second point displaces the first pressed-down point. The coordinate detecting section 103 next judges in S8 that a click has been made at the coordinates identified in S7 as the first point. In S9, the coordinates identified in S7 as the first point are stored in the coordinate storing section 104. The coordinate detecting section 103 then outputs in S3 the coordinate detection result 105 that contains the coordinates of the two points identified in S7 as the first point and the second point, and that notifies a click made at the coordinates identified as the first point. The coordinate detection is then ended.

The coordinate detection result 105 obtained through the above process is used by the touch panel 100 to implement a function of moving the pointer 201 displayed on the screen by pressing one point and selecting the icon 202 by subsequently pressing the second point, namely, a function similar to the one executed by manipulating one button of a mouse.

The coordinate detection described above takes as an example one-click processing in which the second point is pressed once. The coordinate detecting device of this embodiment is also capable of varying processing that is executed at the coordinates of the first point depending on the click count. In this case, the timer 110 is used to detect an interval at which the second point is pressed, and it is judged that a click has been made N times when the second point has been pressed N times within a given period of time (e.g., within one second) (for example, it is judged that a double click has been made when the second point has been pressed twice).

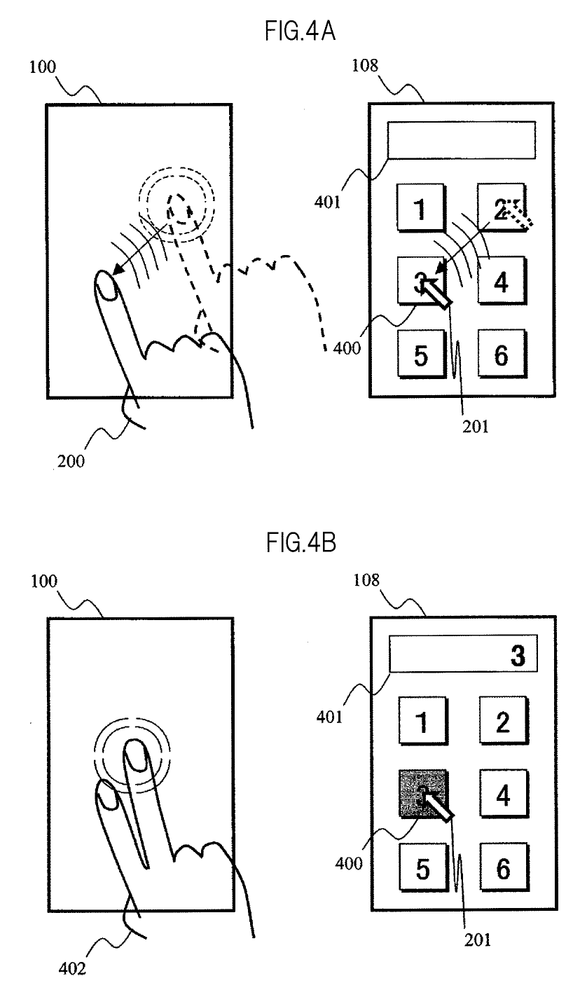

Described next with reference to FIGS. 4A and 4B is a specific example of the GUI application 106 that uses the above coordinate detection result 105. The application 106 illustrated in FIGS. 4A and 4B causes the display 108 to display icons 400 bearing numbers and an output field 401 to which a number born by the icon 400 that is selected with the pointer 201 is output.

A common GUI application that uses a touch panel causes a number to be output to the output field 401 at the time when the finger 200 presses one of the icons 400 on the touch panel 100. With the application 106 of this embodiment, on the other hand, pressing first the icon 400 that bears “2” (the first point) as illustrated in FIG. 4A and then sliding the finger 200 to the icon 400 that bears “3” do not cause neither “2” nor “3” to be output to the output field 401. The icon 400 is selected at the time when one of fingers 402 presses the second point with the pointer 201 pointing the icon 400 as illustrated in FIG. 4B, and the number on the selected icon 400 is output to the output field 401. The application 106 thus performs an operation similar to the one executed by clicking on the icon 400 with a mouse.

The GUI application 106 taken as an example here is one that outputs numbers born on the icons 400. To give another example of the application 106 that uses the coordinate detection result 105 according to this embodiment, each icon 400 may bear an image instead of a number, which is enlarged when the icon 400 is selected, or each icon 400 may be associated with a specific application, which is activated when the icon 400 is selected.

As has been described, with the method of detecting coordinates on the touch panel 100 capable of detecting the coordinates of two points according to this embodiment, the touch panel 100 can implement a function of selecting the coordinates of the first pressed-down point by pressing the second point, namely, a function similar to the one executed by manipulating one button of a mouse. However, the present invention is not limited to pressing a touch panel twice, and is also applicable to when a touch panel is pressed at three points or more.

A method of detecting coordinates on the touch panel 100 according to the second embodiment of the present invention will now be described. A coordinate detecting device of this embodiment has the structure illustrated in FIG. 1, the same as the coordinate detecting device of the first embodiment.

The coordinate detecting method of the first embodiment is simple and the coordinates of the first pressed-down point are selected at the time when the second point is pressed. There are other major mouse functions, one of which is drag & drop. With the drag & drop function, an object such as the icon 202 is selected by clicking a mouse button and, in this state, the mouse is moved (dragging an icon) to move the icon 202 to arbitrary coordinates (dropping an icon).

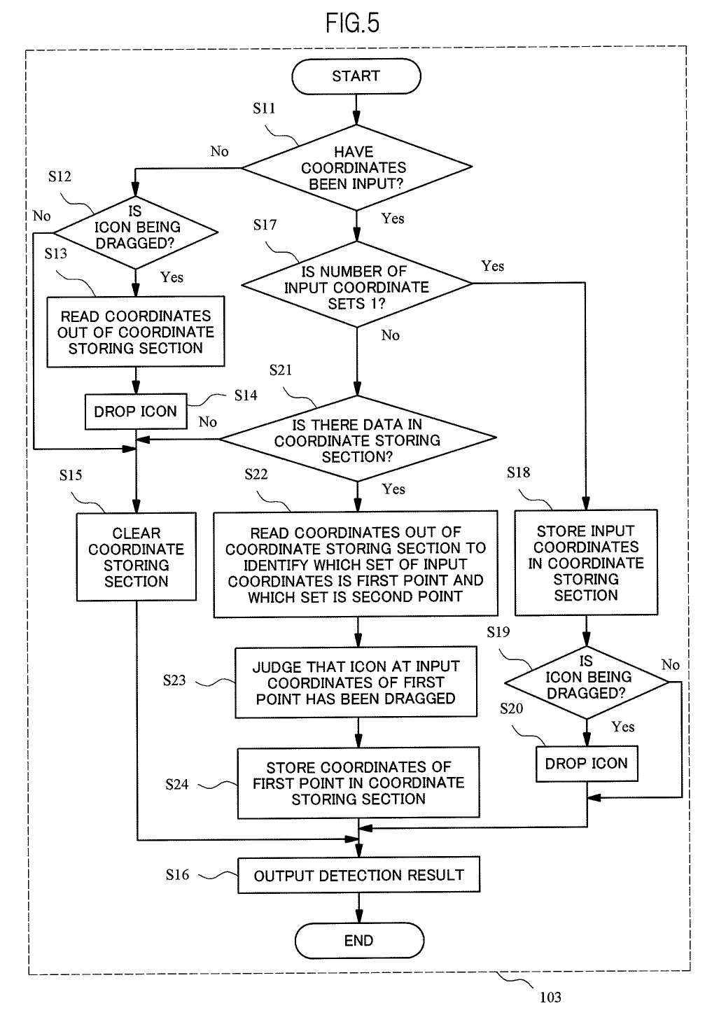

A coordinate detecting method for implementing the drag & drop function of a mouse with the touch panel 100 according to this embodiment is described with reference to a flow chart of FIG. 5 which illustrates processing steps of the coordinate detecting section 103.

The coordinate detecting section 103 first judges in Step S11 whether or not coordinates have been input from the coordinate calculating section 101. When no coordinates have been input (S11: No), whether or not the icon 202 is currently being dragged is judged in S12. When the icon 202 is not being dragged (No), the coordinate storing section 104 is cleared in S15 and the coordinate detection result 105 indicating that no coordinates have been detected is output in S16. Whether the icon 202 is currently being dragged or not can be determined by whether the icon 202 is currently kept pressed or not. When it is judged in S12 that the icon 202 is being dragged (Yes), coordinates are read out of the coordinate storing section 104 in S13 and, in S14, the icon 202 is dropped at the coordinates read in S13, whereby the drag & drop processing is ended. The coordinate detecting section 103 then clears the coordinate storing section 104 in S15 and outputs in S16 the coordinate detection result 105 that contains the coordinate data read in S13 and that identifies that the icon 202 has been dropped at the read coordinates.

When it is judged in S11 that coordinates have been input (Yes), on the other hand, whether or not the input coordinates are of one point is judged in S17. When the coordinates of only one point have been input (Yes), the input coordinates are stored in the coordinate storing section 104 in S18, and then whether or not the icon 202 is currently being dragged is judged in S19. When the icon 202 is not being dragged (No), the input coordinates of the single point are output as the coordinate detection result 105 in S16. When the icon 202 is being dragged (Yes), the icon 202 is dropped in S20, and the coordinate detection result 105 is output in S16 that contains the coordinates data of the single point and that identifies that the icon 202 has been dropped at these coordinates.

When it is judged in S17 that the coordinates of two points have been input (No), whether or not there is data in the coordinate storing section 104 is judged in S21. When no data is found in the coordinate storing section 104 (S21: No), the coordinate storing section 104 is cleared in S15 and the coordinate detection is ended.

When data is found in the coordinate storing section 104 in S21 (Yes), it means that, after one point on the touch panel 100 is pressed, a second point is pressed while the first point is kept pressed. In this case, the coordinates that have been input the last time are read out of the coordinate storing section 104 in S22. Of the coordinates of the two points input this time, the coordinates of one point that are closer to the read coordinates are identified as the coordinates of the first point and the coordinates of the other point is identified as the coordinates of the second point. The coordinate detecting section 103 next judges in S23 that the icon 202 at the coordinates identified in S22 as the first point are dragged this time.

In S24, the coordinates identified in S22 as the first point are stored in the coordinate storing section 104. Thereafter, the coordinate detection result 105 is output in S16 that contains the coordinate data of the two points identified in S22 as the first point and the second point and that identifies that the icon 202 at the coordinates identified as the first point has been dragged. The coordinate detection is then ended.

The coordinate detection result 105 obtained through the above process is used by the touch panel 100 to implement a function of moving the pointer 201 displayed on the screen by pressing one point, dragging the icon 202 by pressing the second point, and dropping the icon 202 by detaching from the second point, namely, a function similar to the drag & drop function of a mouse.

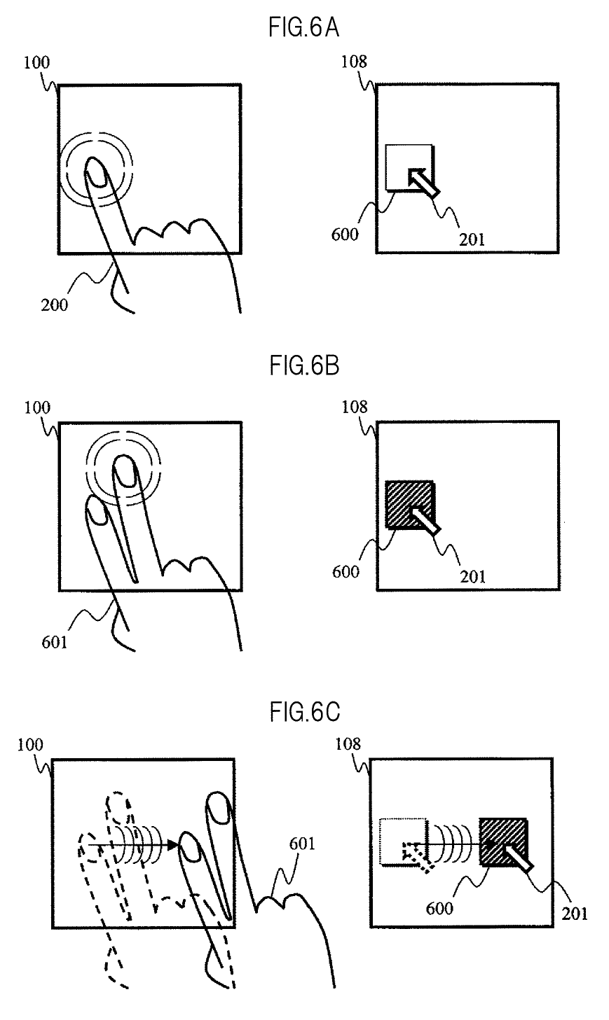

Described next with reference to FIGS. 6A to 6C is a specific example of the GUI application 106 that uses the above coordinate detection result 105. The application 106 illustrated in FIGS. 6A to 6C is capable of drag & drop processing, and causes the display 108 to display an icon 600, which, when dragged, changes its displayed appearance from the one illustrated in FIG. 6A to the one illustrated in FIG. 6B.

With the application 106 of this embodiment illustrated in FIGS. 6A to 6C, the pointer 201 is moved onto the icon 600 while the finger 200 keeps pressing one point on the touch panel 100 as illustrated in FIG. 6A. In this state, one of fingers 601 presses a second point as illustrated in FIG. 6B, which enables the icon 600 to be dragged. Thereafter, while pressing the two points concurrently, the fingers 601 slide over the touch panel 100 as illustrated in FIG. 6C, thereby moving the icon 600. If the one of the fingers 601 is detached from the second point during the dragging of FIG. 6C, the icon 600 can be dropped. The application 106 thus performs an operation similar to the one executed by dragging and dropping the icon 600 with a mouse.

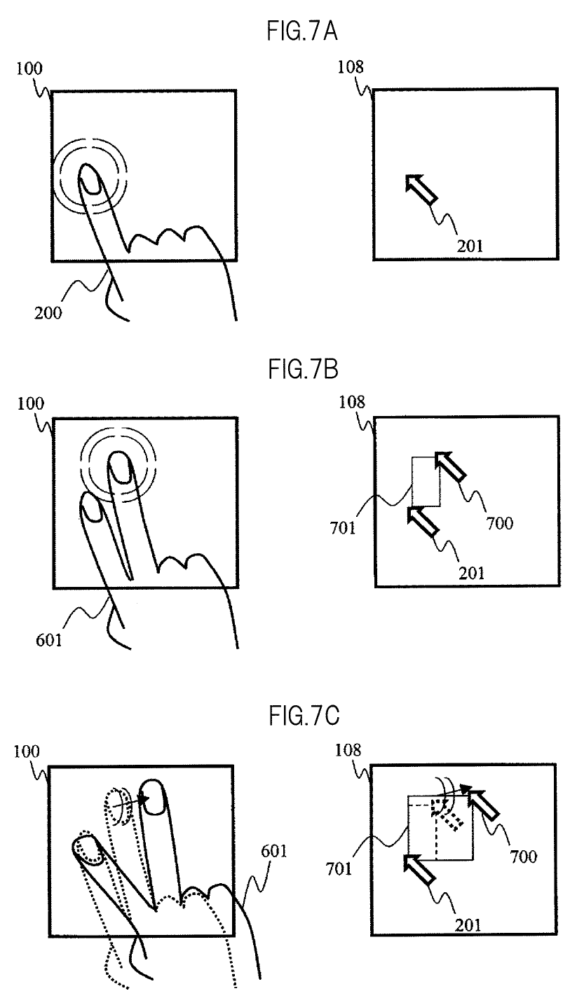

A description will be given with reference to FIGS. 7A to 7C on another specific example of the GUI application 106 that uses the above coordinate detection result 105 but not for drag & drop. The application 106 illustrated in FIGS. 7A to 7C causes the display 108 to display the pointer 201 when a first point is pressed and causes the display 108 to newly display a pointer 700 when a second point is subsequently pressed. An orthogonal area having these two points as opposing corners is selected, and a selected area 701 is displayed on the display 108.

With the application 106 of this embodiment illustrated in FIGS. 7A to 7C, the pointer 201 is displayed on the display 108 when the finger 200 presses one point on the touch panel 100 as illustrated in FIG. 7A. In this state, the one of the fingers 601 presses a second point as illustrated in FIG. 7B, which causes a detection result identifying that the first point has been dragged to be output. Based on this detection result, the selected area 701 having the two pressed-down points as opposing corners is selected as illustrated in FIG. 7B, instead of dragging the icon as the application 106 of FIGS. 6A to 6C does. While the two points are kept pressed concurrently, one of the fingers 601 is slid over the touch panel 100 to change the area of the selected area 701 as illustrated in FIG. 7C. In the example given here, the second point is slid while two points are pressed, but it may be the first point that is slid, or the two points may be slid concurrently.

As has been described, with the method of detecting coordinates on the touch panel 100 capable of detecting the coordinates of two points according to this embodiment, the touch panel 100 can implement functions similar to those of the drag & drop processing and other drag processing of a mouse.

A method of detecting coordinates on the touch panel 100 according to the third embodiment of the present invention will now be described. A coordinate detecting device of this embodiment has the structure illustrated in FIG. 1, the same as the coordinate detecting devices of the first and second embodiments.

While the first embodiment deals with a simple coordinate detection method in which the coordinates of the first pressed-down point are selected at the time when the second point is pressed, a mouse in most cases has a left button and a right button, and hence clicking of the two buttons is distinguished from each other as left click and right click.

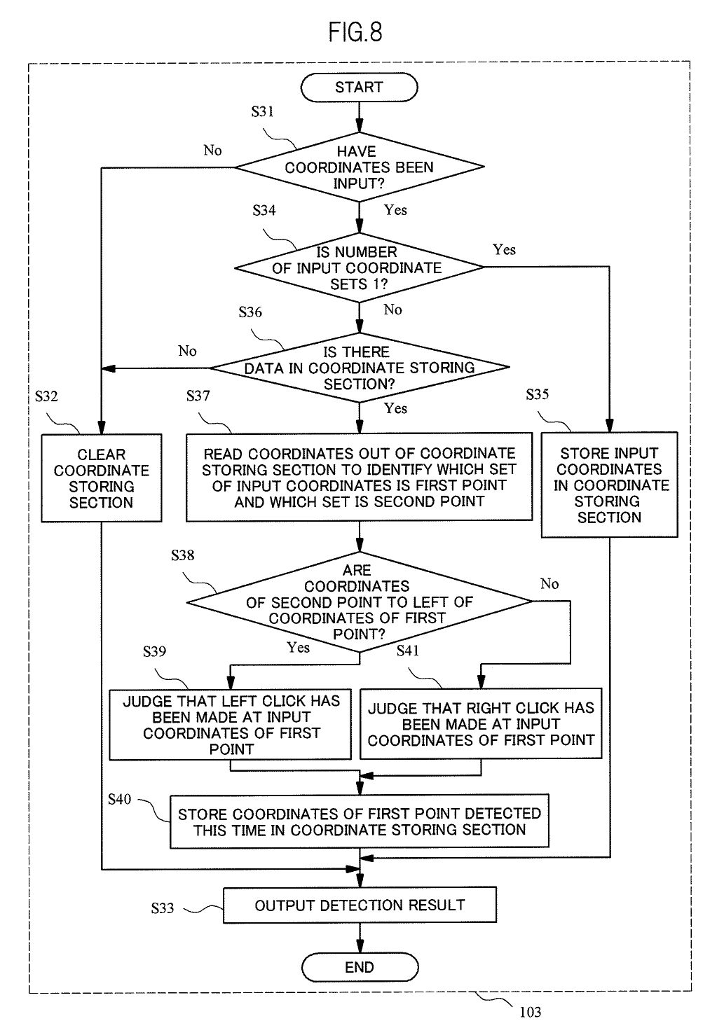

This embodiment therefore describes a coordinate detecting method for implementing the left click/right click function of a mouse with the touch panel 100. The description is given with reference to a flow chart of FIG. 8 which illustrates processing steps of the coordinate detecting section 103.

First, the coordinate detecting section 103 judges in Step S31 whether or not coordinates have been input from the coordinate detecting section 101. When no coordinates have been input (S31: No), the coordinate storing section 104 is cleared in S32 and the coordinate detection result 105 indicating that coordinates have not been detected is output in S33.

When it is judged in S31 that coordinates have been input (Yes), on the other hand, whether or not the input coordinates are of one point is judged in S34. When the coordinates of only one point have been input (Yes), the input coordinates are stored in the coordinate storing section 104 in S35, then the coordinate data alone is output as the coordinate detection result 105 in S33, and then the coordinate detection is ended.

When it is judged in S34 that the coordinates of two points have been input (No), whether or not there is data in the coordinate storing section 104 is judged in S36. When no data is found in the coordinate storing section 104 (S36: No), the coordinate storing section 104 is cleared in S32 and the coordinate detection is ended. When data is found in the coordinate storing section 104 in S36 (Yes), it means that, after one point on the touch panel 100 is pressed, a second point is pressed. In this case, the coordinates that have been input the last time are read out of the coordinate storing section 104 in S37. Of the coordinates of the two points input this time, the coordinates of one point that are closer to the read coordinates are identified as the coordinates of the first point and the coordinates of the other point is identified as the coordinates of the second point. In S38, the coordinate detecting section 103 judges whether or not the coordinates identified in S37 as the second point are to the left of the coordinates identified in S37 as the first point. When the second point is to the left of the first point (Yes), it is judged in S39 that a left click operation has been made at the coordinates identified in S37 as the first point. Then the coordinate detection result 105 is output in S40 that contains the coordinate data of the two points identified in S37 as the first point and the second point and that identifies that a left click has been made at the coordinates identified as the first point. When it is found in S38 that the coordinates identified in S37 as the second point are to the right of the coordinates identified in S37 as the first point (No), the coordinate detecting section 103 judges in S41 that a right click has been made at the coordinates identified in S37 as the first point. Then the coordinate detection result 105 is output in S40 that contains the coordinate data of the two points identified in S37 as the first point and the second point and that identifies that a right click has been made at the coordinates identified as the first point.

The coordinate detection result 105 obtained through the above process is used by the touch panel 100 to implement a function of moving the pointer 201 displayed on the screen by pressing one point and, when a second point is pressed, distinguishing whether the icon 202 is left-clicked or right-clicked from the positional relation between the two points, namely, a function similar to the one executed by manipulating two buttons of a mouse.

The coordinate detection described above takes as an example one-click processing in which the second point is pressed once. The coordinate detecting device of this embodiment is also capable of varying processing that is executed at the coordinates of the first point depending on the click count. In this case, the timer 110 is used to detect an interval at which the second point is pressed, and it is judged that a click has been made N times when the second point has been pressed N times within a given period of time (e.g., within one second) (for example, it is judged that a double click has been made when the second point has been pressed twice).

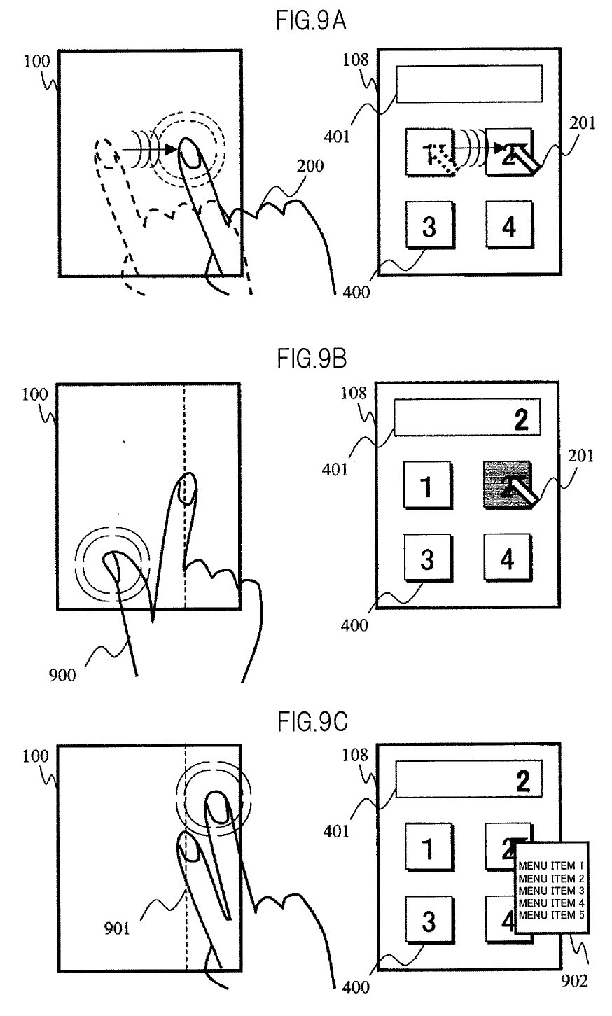

Described next with reference to FIGS. 9A to 9C is a specific example of the GUI application 106 that uses the above coordinate detection result 105. The application 106 illustrated in FIGS. 9A to 9C causes the display 108 to display, as in the first embodiment, the icons 400 bearing numbers and the output field 401 to which a number born by the icon 400 that is selected with the pointer 201 is output. The application is also designed such that the icon 400 pointed by the pointer 201 is selected when left-clicked and, when right-clicked, opens a menu 902 illustrated in FIG. 9C as is the case when a mouse is employed as a pointing device.

With the application 106 of this embodiment, on the other hand, pressing first the icon 400 that bears “1” (the first point) as illustrated in FIG. 9A and then sliding the finger 200 to the icon 400 that bears “2” do not cause neither “1” nor “2” to be output to the output field 401. When the pointer 201 is on the icon 400 and a second point pressed by a finger 900 is to the left of the coordinates of the first pressed-down point as illustrated in FIG. 9B, it is recognized that the icon 400 has been left-clicked, and the number “2” on the icon 400 selected by the left click is output to the output field 401. When the pointer 201 is on the icon 400 and a second point pressed by a finger 901 is to the right of the coordinates of the first pressed-down point as illustrated in FIG. 9C, it is recognized that the icon 400 has been right-clicked, and the menu 902 is opened.

The GUI application 106 taken as an example here is one that outputs numbers born on the icons 400. To give another example of the application 106 that uses the coordinate detection result 105 according to this embodiment, each icon 400 may bear an image instead of a number, which is enlarged when the icon 400 is selected, or each icon 400 may be associated with a specific application, which is activated when the icon 400 is selected.

In the above description of the GUI application 106 according to this embodiment, left click and right click are distinguished from each other based on whether the coordinates of the second pressed-down point are to the left or right of the coordinates of the first pressed-down point. Instead of left and right with respect to the first point, the screen area may be divided into an upper segment and a lower segment in relation to the first point, or may be divided diagonally, to assign the left click function and the right click function separately to the screen area segments. Alternatively, more button operations than the two button operations, left click and right click, can be assigned if the screen area is divided into three or more segments and the segments are distinguished from one another when the coordinates of the second pressed-down point are analyzed.

As has been described, with the method of detecting coordinates on the touch panel 100 capable of detecting the coordinates of two points according to this embodiment, the touch panel 100 can implement a function of distinguishing whether a left click or a right click has been made at the coordinates of a first pressed-down point from the location of a second pressed-down point with respect to the first point, namely, a function similar to the one executed by manipulating two buttons of a mouse.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A coordinate detecting device comprising:
a touch panel capable of detecting coordinates of two or more points where the touch panel is touched by a user;
a coordinate storing section which stores the coordinates detected in the touch panel; and
a coordinate detecting section which, when the coordinates of two or more points are detected in the touch panel, uses the coordinates that have been stored in the coordinate storing section to identify an order in which the detected coordinates of two or more points are pressed, and determines what processing is to be performed on a displayed object according to the coordinates of the first point based on a positional relation of the coordinates of the one of subsequent points with respect to the coordinates of the first point.

2. A coordinate detecting device according to claim 1, wherein the touch panel lengthens an interval of detecting coordinates when touching on the touch panel by the user is not detected for a preset period of time or longer, and shortens the interval of detecting coordinates when the touching on the touch panel by the user is kept detected for a preset period of time or longer.

3. A coordinate detecting device according to claim 2, wherein, when coordinates of a single point are detected in the touch panel, the coordinate detecting section stores the coordinates in the coordinate storing section and outputs the coordinates as a detection result of the coordinate detecting section.

4. A coordinate detecting device according to claim 3, wherein, when coordinates of a second point are detected after the coordinates of the single point are detected in the touch panel, the coordinate detecting section stores, the coordinates detected as the first point based on the coordinates read out from the coordinate storing section, and outputs detection result data that contains the coordinates of two points detected as the first point and the second point and that indicates that the coordinates detected as the first point have been selected at a time when the second point has been touched.

5. A coordinate detecting device according to claim 4,
wherein the coordinate detecting section stores an interval between cessation of detection of the coordinates of the second point after the coordinates of the two points are detected in the touch panel and detection of the coordinates of the second point once again, and
wherein, when the coordinates of the second point are detected in succession within a preset period of time, the coordinate detecting section counts a number of times that the second point is detected and varies processing that is to be performed on the displayed object according to the coordinates detected as the first point depending on the counted number of times.

6. A coordinate detecting device according to claim 3,
wherein, when the coordinates of the second point are detected for the first time after the coordinates of the first point are detected in the touch panel, the coordinate detecting section stores the coordinates detected as the first point based on the coordinates read out from the coordinate storing section, and outputs data that contains the coordinates of two points detected as the first point and the second point and that indicates that the coordinates detected as the first point have been selected at a time when the second point has been touched, and
wherein, when the coordinates of the two points continue to be detected after the data is output, the coordinate detecting section stores the coordinates detected as the first point this time based on the coordinates detected last time as the first point, which has been read out from the coordinate storing section, and keeps outputting data that contains the coordinates of the two points detected as the first point this time and the second point and that indicates that the coordinates detected as the first point this time has been selected.

7. A coordinate detecting device according to claim 3,
wherein, when the coordinates of the second point are detected for the first time after the coordinates of the first point are detected in the touch panel, the coordinate detecting section stores the coordinates detected as the first point based on the coordinates read out from the coordinate storing section,
wherein the coordinate detecting section identifies in which of two screen area segments divided into upper and lower segments or left and right segments, or divided diagonally, the coordinates detected as the second point are located with respect to the coordinates detected as the first point,
wherein, after a location of the coordinates detected as the second point with respect to the first point is identified, the coordinate detecting section selects one of two preset processing options based on which screen area segment the coordinates detected as the second point belong to, and
wherein the coordinate detecting section then outputs data that contains the coordinates of two points detected as the first point and the second point and that indicates that the selected one of the two processing options is to be performed on the displayed object according to the coordinates detected as the first point.

8. A coordinate detecting device according to claim 7,
wherein, when identifying the location of the coordinates detected as the second point with respect to the coordinates detected as the first point, the coordinate detecting section identifies in which of three or more screen area segments the coordinates detected as the second point are located with respect to the coordinates detected as the first point, the three or more screen area segments including the two screen area segments that are divided into upper and lower segments or left and right segments, or divided diagonally, and
wherein, after the location of the coordinates detected as the second point with respect to the first point is identified, the coordinate detecting section selects, based on which screen area segment the coordinates detected as the second point belong to, one of preset processing options provided for a number of the screen area segments, and
wherein the coordinate detecting section then outputs data that contains the coordinates of the two points detected as the first point and the second point and that indicates that the selected one of the preset processing options provided for the number of the screen area segments is to be performed on the displayed object according to the coordinates detected as the first point.

9. An operation method using a touch panel that is capable of detecting coordinates of two or more points where the touch panel is touched by a user, comprising:
a step for storing coordinates detected in the touch panel in a coordinate storing section;
a step for using, when the coordinates of two or more points are detected in the touch panel, the coordinates that have been stored in the coordinate storing section to identify an order in which the detected coordinates of two or more points are pressed; and
a step for determining what processing is to be performed on a displayed object according to the coordinates of the first point based on a positional relation of the coordinates of the one of subsequent points with respect to the coordinates of the first point.
